(19) United States
(12) Patent Application Publication
(10) Pub. No.: US 2011/0193950 A1
(43) Pub. Date: Aug. 11, 2011

(54) Application of microscopic linear array scanner for measuring rate of change of live organisms

(76) Inventor: Stephen Liye Chen, El Monte, CA (US)

(21) Appl. No.: 12/658,493

(22) Filed: Feb. 9, 2010

(51) Int. Cl. H04N 7/18

(52) U.S. Cl. 348/79; 348/E07.085

(57) ABSTRACT

The invention creates a method of single lane scanning of live organisms by CCD linear array scanner to collect valid data while minimizing photonic interruption to said live organisms. The invention further creates a simple solution to upgrade manual microscopes for measuring rate of change of live organisms. A calculation method is included to measure rate of change of live organisms.

### BACKGROUND OF THE INVENTION

1. Field of Invention

The present invention relates to biological applications of microscopic scanners. In particular, it relates to methods of using microscopic scanners to measure rate of change of live organisms with minimized photonic interruption.

2. Description of the Prior Art

CCD array sensors are popular components of electronics. There are two kinds of CCD array sensors, linear arrays and area arrays. Area array sensors are used for digital cameras while linear array sensors are used for scanners. The development of biological applications of linear array sensors is significantly slower than that of area arrays.

Aperio Company (Vista, Calif. USA, the assignee of U.S. Pat. No. 7,457,446), for example, utilizes linear array sensors in microscopic scanners to create virtual slides for pathologists in clinic and education. Fixed tissue specimen on a glass slide is scanned repeatedly, lane by lane, cross the majority of tissue specimen. Captured images are transferred to a computer for post processing. Overlaps between adjacent scan lanes are required for stitching all scan lanes together to form a giant image file of the entire tissue specimen, which is viewable remotely. Unfortunately, Aperio Company limits the biological application within fixed pathological tissues and fails to include live organisms. Further more, Aperio creates a computer problem. The image file of the entire tissue specimen is so huge that the computer process becomes a bottleneck.

Palcic et al, U.S. Pat. No. 4,700,298, proposes a method to scan at least several square centimeters for locating live cells growing at low density. Palcic et al fails to recognize that the light source of the scanner, such as a high density UV light, is killing the live cells under long exposure. As a result, the proposed method failed to become popular since its patent filing in 1984.

Time lapse movie is a useful method known by scientific communities. A culture dish is positioned in a microscope for a long period of time. A cell is imaged repeatedly during delayed time intervals. After completion, all images can be played back as a movie to see the behavior of the cell. This movie is scientifically meaningful. But it remains as luxury showcase and fails to be an affordable tool for daily routine activities. The whole system is very expensive, including microscope, stage culture incubator, imaging device, computer, and specialized software. For imaging a single cell, The whole system has to be occupied for a long time without accessibility of other users. Further more, a statistic question remains: Does this single cell in movie represent the whole population?

Without affordability to time lapse movie, the majorities of cell culture communities have to collect data from fixed cells. Valuable information has be wasted while cells alive in culture.

There are two kinds of questions. Qualitative questions can be answered by yes or no. Most scientific questions are quantitative and should be answered precisely by a percentage ratio or rate of change. But, due to technical difficulties, scientific questions have been heavily addressed without valid quantitative tool.

### SUMMARY OF THE INVENTION

It is, therefore, the object of the invention to create feasible methods of quantitative measurements. The invention is made scientifically meaningful, practically feasible, and financially affordable by knowledge combination of statistics, electronics, instrumentation, mechanical engineering, and cell biology. The combined knowledge gains significant achievement. It converts luxury showcase of time lapse movie into an affordable tool of daily activities. It enables low-end manual microscopes to measure rate of change of live organisms.

### DESCRIPTION OF THE DRAWINGS

FIG. 1 is a diagram showing a pattern of single lane scanning cross multiple wells of a culture enclosure.

FIG. 2 is a top view of a mechanical device for enabling a manual inverted microscope to measure rate of change of live organisms.

FIG. 3 is an enlarged top view of the mechanical device showing a locker interacting with positioning markers.

FIG. 4 is an enlarged sectional side view of the mechanical device showing structure of wheels.

FIG. 5 is side view of the mechanical device being used on a manual stage of an inverted microscope.

FIG. 6 is a diagram showing a circle of imaging path when using manual inverted microscope for sequential imaging of a culture enclosure.

### DETAILED DESCRIPTION OF THE INVENTION

In sciences and surveys, a proper sampling strategy is the key to reach balance between data confidence and feasibility. Aperio Company exams major portion of a population. This might be a requirement for clinic diagnoses. But to sciences and surveys, it is a typical example of over sampling, which creates more problems than benefits. This might be a reason why Aperio Company fails to include live organisms for virtue slides. Live organisms in culture are usually very fragile and sensitive to lights. The illumination of scanners, such as a high density UV beam, can cause cell death due to photodamage and phototoxicity if the exposure time is extended. In contrast to over sampling, time lapse movie to a single cell is an example of under sampling, which gives no sufficient confidence to a survey of a population.

The invention proposes a single lane scan method for collecting data of individuals of a population. The photonic interruption should be minimized so that live organisms can be used as specimen. The invention recognizes that a single scan quickly cross a culture well can cover enough area. For example, a round culture well with 8 mm diameter has a total area of 50.24 mm². To a 4096 pixel linear array sensor, the width of a single scan lane is about 0.94 mm when using 0.23 um/pixel resolution (equal to 40× objective of a microscope). By a single scan cross the center of the culture well, the imaged area is about 7.5 mm², which is 14.9% of the total area. Alternatively, by reducing scan resolution to 0.46 um/pixel (equal to 20× objective), the imaged area increases to 29.8% of the total area.

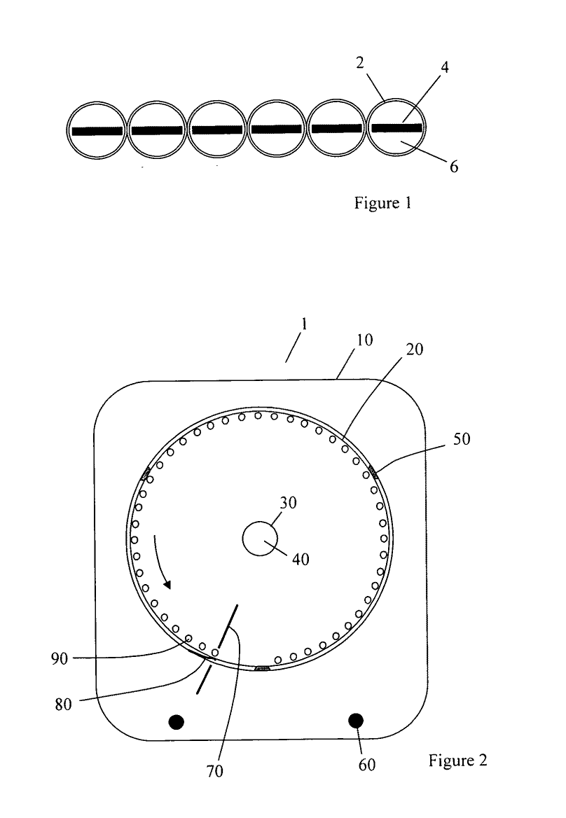

FIG. 1 shows a pattern of single lane scan passing 6 wells of a multi-well plate. A computer program should be set to run a single lane scan sequentially for the wells. Scan length in each well should be slightly less than the diameter of the well. In FIG. 1, a first well 2 supports a population 6 of live organisms. A single lane scan captures images of individuals 4 of population 6. Imaged individual 4 is only a small portion of population 6 in culture well 2. The majority of population 6 is excluded from the scan.

Most cultured organisms are uniformly distributed. The data from a single lane scan represents 14.9% of a population, which gives sufficient statistic confidence. Fast single lane scan ensures viability of the cultured organisms by reducing exposure time to minimal essential level. The additional benefits are: The image file is dramatically reduced. There is no requirement of lane overlapping, image stitching, or powerful computer.

The invention further creates a calculation method for application of microscopic scanners. In nature, Individual variations are unavoidable during biological processes and events. False conclusion can be made if invalid calculation method being used. For easy understanding, a case of two-person's race between A and B is given below. A starts early and runs slowly to halfway. B runs fast but just starts. Old method concludes that A runs faster because A is in front of B. The invention measures their speeds respectively and concludes that B runs faster even though B is still behind A. In the case, the invention eliminates the biggest variation, starting at different times, so that a correct answer is concluded. In cultured organisms, individual cells start their growth and development at different times so that false conclusion can be made when using fixed culture for data analysis.

The calculation method of the invention needs data from two identical scans, scan A and scan B, of the same individuals. A particular time length is inserted between the two scans. Then a formula, (data B−data A)/time, is used to calculate the rate of change. In the formula, time is a divisor to divide the difference between the data of the second scan and the data of the first scan. The time gap should be compatible to the change of interest in study, such a 30 minutes for the change of a protein concentration or 20 hours for a growth rate. Aperio Company failed to measure rate of change because there is no biological life in fixed pathological specimen. Time lapse movies have plenty images and time gaps. But it is barely, if any, used as affordable tool for daily activities due to its luxury status.

The calculation method of the invention is useful for measuring a variety of events in cultures, such as cell growth, cell death, or accumulation of a protein. The single lane scan method and calculation method of the invention can be used with a variety of hardwares, either a fully automated high-end system controlled by a computer program or a low-end manual system controlled by human hands. Below are examples of applications.

### Application Example 1

### Measure Rate of Change Using Automated Microscopic Scanner

Computerized microscopic linear scanner is an expensive system from suppliers. It uses a special computer program to control motorized X Y Z movement and instant auto focusing feature. Multi-well stage incubators are available from many suppliers, such as Warner Instruments Company (Hamden, Conn. USA). The invention proposes a combination of a stage incubator with a microscopic linear array scanner to measure rate of change of live organisms. Using the modified scanner system, a 96-well plate in the stage incubator can be positioned to a variety of X Y coordinates. To perform a single lane scan of live organisms in the culture enclosure, the procedure is as follows:
a. Select a suitable resolution and set the computer program to perform a single lane scan cross wells sequentially to capture 1 image per well.
b. Anchor the 96-well plate into stage incubator and start a run A of the computer program to collect data of scan A.
c. Add a testing compound to wells at different dosages (from zero to highest) after run A. This step is optional.
d. Keep the multi-well plate in suitable culture condition and wait for a suitable time gap. The plate can be removed from scanner if desire.
e. Repeat the computer program for a run B after the time gap to collect data of scan B. That is, the same individuals are imaged twice at different times.
f. Calculate rate of change of each individual using a formula of (data of scan B−data of scan A)/time, where time is a divisor to divide the difference between scan B and scan A.
g. Show effect the testing compound by comparing rate of change at different dosages.

To use the expensive system efficiently among multiple projects and users, stage incubator can be modified to hold numerous plates. A shifting means can be used to change plates automatically.

### Application Example 2

### Measure Rate of Change of Live Organisms Manually

Thousands of manual inverted microscopes are currently functional world-wide via accumulation of decades. The low-end equipments are still the most preferred systems over motorized microscopes for daily observation purposes. Their beauty is the freedom of fast stage movement by human hands. Their problem is the inability of registering particular X Y coordinates, which makes recurring imaging of particular targets unfeasible. The low-end working habit, unfortunately, leads to a loss of creative vision that daily observation can be actually an opportunity to collect valuable live data.

The invention creates a novel idea of using manual microscopes to measure rate of change of live organisms. The invention further makes the idea feasible by using combined knowledge of instrumentation and mechanical engineering. With a simple rotary system on stage. A manual inverted microscope can be empowered for live cell imaging easily and quickly by human hands.

FIG. 2 is a top view of a rotary system 1. A station 10 holds a rotary plate 20 via three wheels 50. Rotary plate 20 has a holder 30 for holding a culture enclosure. Live cells are viewable by objective through a hole 40. Line 70 indicates the initial position of rotary plate 20 when preparing for live imaging. By a finger touch, rotary plate 20 can be turned anti-clock wise smoothly from initial position to a next positions. Each position has different X Y coordinates. The different X Y coordinates are represented by marking structures, which includes an spring 80 as indicator and visual markers 90.

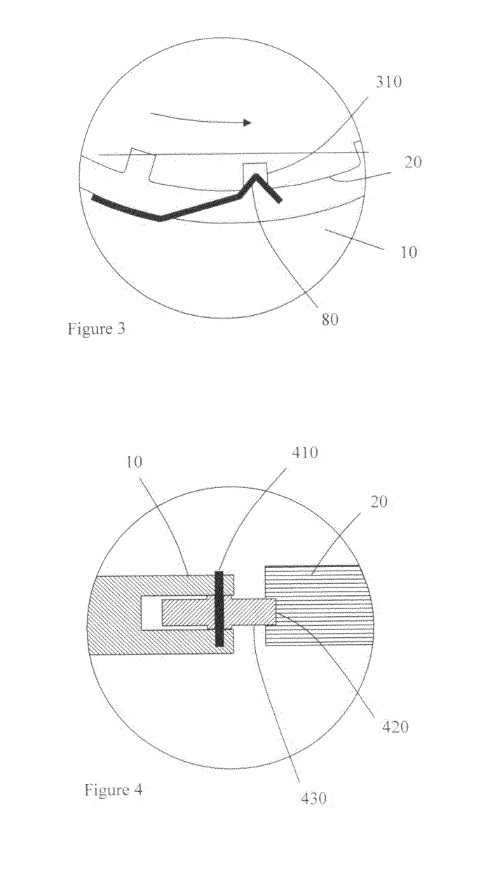

FIG. 3 shows the position control of rotary plate 20. Numerous notches 310 are made along edge of rotary plate 20. A spring 80, made from a sheet metal, is used as an indicator. Spring 80 engages notches with a proper strength so that rotary plate 20 can be locked steadily to a plurality of different X Y coordinates during a rotation. Those different positions will be revisited easily without the need of any adjustment. When spring 80 engages into a notch, an audio sound tells the operator to take a snapshot at that position, then a next snapshot at next notch. In this manner, 40 snapshots can be completed quickly in a time range like a brief daily observation.

FIG. 4 is a sectional side view showing how rotary plate 20 is supported. Three wheels 430 are installed to station 10 by steel pin 410. One of the three wheels should be adjustable so that precise engagement between wheels 430 and rotary plate 20 can be maintained.

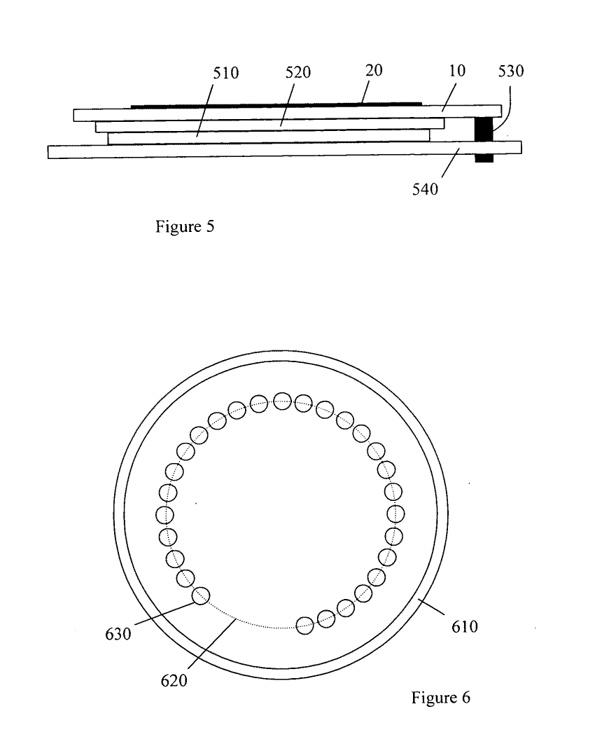

FIG. 5 shows how to engage rotary system 1 with a manual stage of an inverted microscope. Typical manual stages have three layers, an unmovable base 540, a middle layer 510 for X-movement, and a top layer 520 for Y-movement. Station 10 is placed flatly on top layer 520. A pair of lockers 530 bypasses unwanted X Y movements by engaging with base 540 directly. There are many ways, such as two holes, to anchor lockers 530 with base 540. For multi-functions of the microscope, the engagement should ensure rotary system 1 being placed and removed easily without possibility of position variation.

Co-localization is the key requirement for revisiting previous X Y coordinates. The design of the invention enhances precision without paying high price of fabrication. For instance, if the variation of engagement between spring 80 and notches 310 is 2 micrometers, then, the mismatch of two snapshots of a target is reduced to 0.17 micrometer, which is a 12-fold enhancement. The 12-fold precision is achieved by a 12-fold difference in diameters. Rotary plate 20 is 180 mm in diameter. A imaging circle 620, as illustrated in FIG. 6, has a diameter of 15 mm, which is a 12 time reduction in diameter. To see if the precision is enough, a calculation is given here. An imaging field of 20× objective is about 1300 micrometers wide. The variation of 0.17 micrometer equals to 0.013% of the pictured area. It means 0.013% of the two snapshots can not be used to generate data. In other words, the co-localization can reach 99.999% accuracy during repeated rotations.

To measure rate of change manually, the procedure is as follows:
a. Engage rotary system 1 with a manual stage of an inverted microscope to bypass unwanted X Y movement.
b. Set initial working condition, including digital camera, objective, focusing, and rotary plate 20.
c. Place a culture enclosure into holder 30, check focus, and take a first picture 630, as shown in FIG. 6.
d. Turn rotary plate 20 anti-clock wise to engage a next notch and take a next picture.
e. Repeat step d until desired amount of pictures being captured. Focus image manually if necessary during the rotation.
f. Add a testing compound to culture and keep the culture enclosure in proper culture condition for a suitable time length. This is an optional step.
g. Repeat steps of b, c, d, e above for revisiting previous positions and take a second set of pictures respectively.
h. Calculate rate of change of each individual using formula of (data of second pictures−data of first pictures)/time.
i. Determine effect of testing compound by comparing rate of change from treatments of different dosages.

Rotary system 1 can be fabricated from a sheet of suitable metals for stability and precision. In FIG. 6, the diameter of imaging circle 620, such as 20 mm, 15 mm, or 10 mm, can be chosen by the position where rotary system 1 being installed to base 540. Imaging circle 620 of 10 mm diameter has advantage of minimized shift of focus during snapshots. FIG. 6 shows a culture enclosure 610 with an OD of 22 mm. A 15 mm imaging circle 620 is used for taking images sequentially, starting from a first snapshot 630.

Although the description above contains specifications. It will apparent to those skilled in the art that a number of other variations and modifications can be made in this invention without departing from its spirit and scope. For example, single lane scan can be replaced by two lane scan. Rotary plate 20 can be used with fully automated linear array scanners. Wheels 50 can be replaced by ball bearings. Spring 80 can be replaced by other structures. Rotation action of rotary plate 20 can be replaced by straight line movement along X-axis or Y-axis. A stepper motor can be used to control rotary plate 20. Addition of testing compound after a first imaging can be omitted. Therefore, the description as set out above should not be constructed as limiting the scope of the invention but as merely providing illustration of one of the preferred embodiments of the invention.

1. A method of scanning live organisms in a culture enclosure using a system of a automated microscopic scanner controlled by a computer program, comprising steps of;
a) providing said automated microscopic scanner being compatible with said culture enclosure;
b) setting said computer program to run a single lane scan for minimizing photonic interruption of said live organisms; and
c) run said computer program to capture images of individuals of said live organisms.

2. A method to enable a manual stage of a microscope to revisit a plurality of X Y coordinates, comprising steps of;
a) providing a system engaging with said manual stage, including,
a locker bypassing unwanted movement of said manual stage,
a device with marking structures to represent said X Y coordinates respectively, and
an indicator reporting said X Y coordinates by detecting said marking structures respectively; and
b) incorporating said system to said manual stage so that said microscope being capable of measuring rate of change of live organisms.

3. The method of claim 3 wherein said system makes circular movement.

4. A method for measuring rate of a change of live organisms in a culture enclosure using a microscopic device with imaging sensors, comprising steps of;
a) providing a first means for revisiting a plurality of X Y coordinates and a second means for said microscopic device to be compatible with said culture enclosure;
b) capturing a first set of images of individuals of said live organisms at said plurality of X Y coordinates respectively by either running a computer program or using human hands, said individuals being substantially less than said live organisms;
c) keeping said culture enclosure in suitable condition for a time length compatible to said change of said live organisms;
d) capturing a second set of images of said individuals at said plurality of X Y coordinates by either running said computer program or using said human hands; and
e) calculating said rate of change using said time length as a divisor to divide the difference between said second set of images and said first set of images.

5. The method of claim 5 wherein said microscopic device is either a fully automated microscopic scanner or a manual inverted microscope.
